(19) United States
(12) Patent Application Publication
(10) Pub. No.: US 2003/0160427 A1
(43) Pub. Date: Aug. 28, 2003

(54) Reinforcing bracket for a trailer frame

(75) Inventors: Bernard F. Garceau, Granger, IN (US); Jason D. Collins, Elkhart, IN (US)

Correspondence Address: HAHN LOESER & PARKS, LLP, TWIN OAKS ESTATE, 1225 W. MARKET STREET, AKRON, OH, 44313, US

(73) Assignee: Norco Industries, Inc.

(21) Appl. No.: 10/081,254

(22) Filed: Feb. 22, 2002

(51) Int. Cl. B60D 1/24

(52) U.S. Cl. 280/414.1; 280/400

(57) ABSTRACT

A reinforcing bracket for a trailer frame comprises a first side that bolts onto one frame member of a trailer frame, a second side that bolts onto a second member of a trailer frame, and a third side that bolts onto a flange of one or both members. Both the first side and second side comprise a plurality of dimples that nest into dimples in the trailer frame members. Each dimple has an aperture therein that corresponds to an aperture in the frame members, enabling the bracket to be bolted to the frame members. The third side of the bracket is approximately ninety degrees to both the first and second sides, and includes at least one aperture that corresponds to an aperture in a flange of one or both of the frame members.

### TECHNICAL FIELD

The present invention relates to brackets, and more specifically, to reinforcing brackets for trailers.

### BACKGROUND OF THE INVENTION

Trailer frames, such as boat trailers, horse trailers, utility trailers, and the like are typically manufactured by welding frame members together. Typical frame members include flat, L-shaped or U-shaped metal rail sections or tube sections. Although welded trailer frames provide strength to frame member joints, they also trigger a number of problems with, inter alia, shipping and storage.

One problem with welded trailer frames is that they are shipped to wholesalers and/or retailers as a completed frame. Because the entire frame is pre-assembled, only a few trailers can be shipped at a time. A second problem with welded trailers is inventory. Entities that sell trailers and entities that use trailers in manufacturing other equipment, such as recreational vehicles, must stock trailer frames pre-assembled. Such inventoried trailers take up significant storage space, which limits the number and diversity of trailers available in stock.

One solution to the problems associated with welded trailer frames is a trailer frame that bolts together instead of being welded together. In such a bolted trailer frame, individual components of trailers can be shipped in greater quantities and stored in greater quantities, because each trailer could be assembled as needed. However, one problem of bolted trailer frames is the strength of the joints between frame members, such as the joint between an A-frame member and cross member. Accordingly, there is a need for a reinforcing bracket that provides durability and strength to the joint between frame members. Therefore, the present invention is hereby presented.

### BRIEF SUMMARY OF THE INVENTION

It is an object of the present invention to provide a reinforcing bracket for trailer frames that bolts onto the trailer frame members. It is another object of the present invention to provide a reinforcing bracket for trailer frames that provides a strong joint between two members of a trailer frame.

A reinforcing bracket for a trailer frame comprises a first side that bolts onto one frame member of a trailer frame, a second side that bolts onto a second member of a trailer frame, and a third side that bolts onto a flange of one or both members. The angle formed between the first and second sides of the bracket is substantially equal to the angle formed by the junction of the two frame members at the point of attachment of the reinforcing bracket.

The first and second sides of the bracket comprise at least a plurality of dimples that correspond to dimples in the frame members. When the bracket is bolted onto a trailer frame, the dimples in the first and second side of the bracket nest into dimples in the frame members. This nesting effect enables loads to go through the bracket and into the frame members, as opposed to loads primarily going into the bracket.

Preferably, the middle of each dimple in the first and second sides comprises an aperture. The aperture corresponds to an aperture in the dimple of the frame member, and receives a bolt or other fastener known in the art. In operation, a user inserts a bolt or other fastener through each aperture in the first and second sides of the bracket and through each corresponding aperture in the frame members, and secures each bolt with a nut or other fastening device.

The third side of the bracket is preferably substantially perpendicular to both the first side and second side of the bracket. In a preferred embodiment, the third side of the bracket is partially bilaminar, formed by bending elongated extensions of the first and second sides perpendicular to said first and second sides. The third side of the bracket comprises at least one aperture that corresponds to an aperture in the flange of one or both of the two frame members. In operation, the user inserts a bolt through the aperture in the third side of the bracket and through the corresponding aperture in a flange of one or both frame members. Subsequently, the user secures the third side of the bracket to the cross member by a nut or other fastening device.

### BRIEF DESCRIPTION OF THE SEVERAL VIEWS OF THE DRAWINGS

FIG. 1 is a front perspective view of a reinforcing bracket for a trailer frame, in accordance with a preferred embodiment of the present invention.

FIG. 2 is a rear perspective view of a reinforcing bracket for a trailer frame, in accordance with a preferred embodiment of the present invention.

FIG. 3. is a top view of a reinforcing bracket for a trailer frame, in accordance with a preferred embodiment of the present invention.

FIG. 4 is a perspective view of a trailer with reinforcing bracket, in accordance with a preferred embodiment of the present invention.

FIG. 5 is a perspective view of an A-frame section of a trailer with reinforcing bracket, in accordance with a preferred embodiment of the present invention.

### DETAILED DESCRIPTION OF THE INVENTION

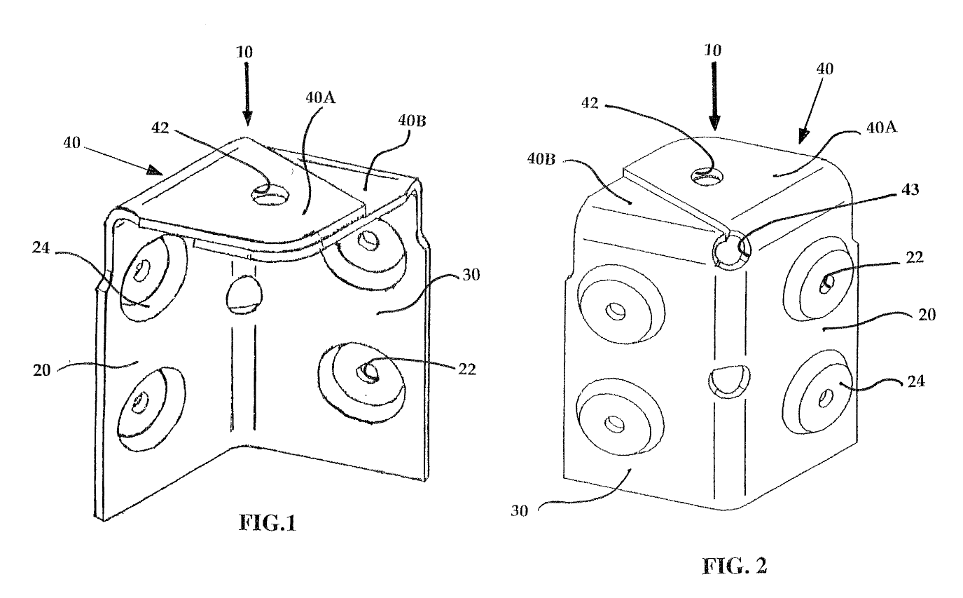

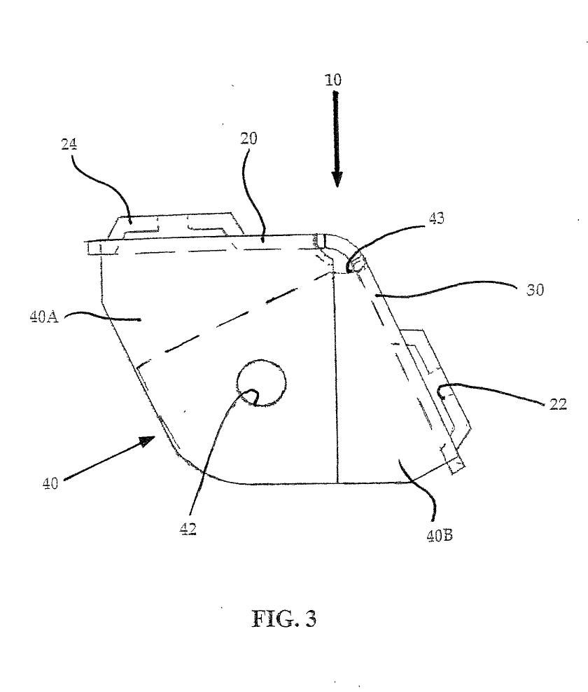

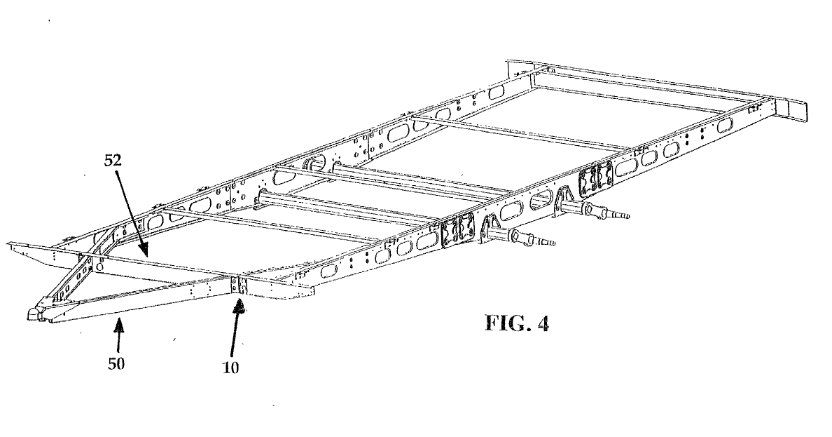

Reference will now be made in detail to the present invention, as illustrated in the accompanied drawings. As illustrated in FIGS. 1-2, a preferred embodiment for a reinforcing bracket for a trailer frame (“bracket”), generally identified by reference number 10, comprises a first side 20 that fastens to a body of a first member of a trailer frame, a second side 30 that fastens to a body of a second member of a trailer frame, and a third side 40 that fastens to a flange of either the first member, the second member, or both members if the members comprise flanges at the installation location.

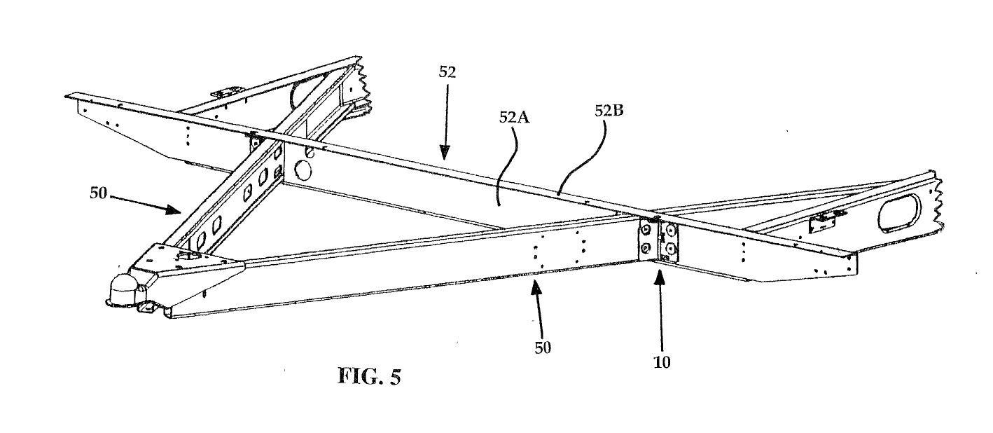

The angle formed between the first side 20 and second side 30 is substantially equal to the angle formed by the two frame members to which the bracket fastens at the point of attachment of the bracket 10. As seen in FIG. 5, a preferred embodiment of the bracket 10 attaches to an A-frame member 50, a cross-member body 52A, and a cross-member flange 52B. Preferably, the bracket 10 attaches to the front major angle formed by an A-frame member and a cross-member, again as seen in FIG. 5. As such, the angle between the first side 20 and second side 30 would be greater than ninety (90) degrees. However, the bracket 10 may optionally attach to the front minor angle formed by an A-frame member and a cross-member. Accordingly, the angle formed between the first side 20 and second side 30 would be less than ninety (90) degrees.

The first side 20 and second side 30 of the bracket 10 include a plurality of dimples 24. In a preferred embodiment, the first side 20 and second side 30 each have two dimples that are substantially vertically oriented. However, other orientations, such as horizontally spaced dimples 24, are contemplated, and can be utilized without deviating from the scope of the present invention.

Each dimple 24 corresponds to a dimple in the frame members to which the bracket 10 attaches. When the bracket 10 is fastened to the frame members, the dimples 24 in the first side 20 and second side 30 of the bracket 10 “nest” into the corresponding dimples of the frame members. This “nesting” of the bracket 10 and frame members provides additional strength to the joint between the two frame members, by allowing loads to flow through the bracket and into the frame members, instead of flowing primarily into the bracket.

In a preferred embodiment, the center of each dimple 24 comprises an aperture 22 that corresponds to an aperture (not shown) in the frame member to which the particular bracket side 20, 30 fastens. When fastening the bracket 10 to frame members, the user inserts bolts or other fastening devices (not shown) through the apertures in each dimple and through the corresponding apertures in the frame members. Subsequently, the user secures the bracket 10 to the frame members via nuts or other known fastening devices. When the bracket is secured to the frame members, the dimples 24 in the bracket “nest” into the dimples in the frame members, providing strength to the joint.

The “nesting” of the plurality of dimples 24 in the first side 20 and the second side 30 into dimples in the frame members provides an increase in torque resistance of the bracket 10 in comparison with a bracket without dimples. In a bracket without dimples, forces or loads on the bracket would be resisted via the fastening devices such as bolts and nuts. In the present invention, the “nesting” dimples allow forces to flow into the trailer frame. The increase in torque resistance prevents twisting of the bracket when loads are applied to the trailer frame.

As seen in FIG. 1, the third side 40 of the bracket 10 is approximately ninety degrees to both the first side 20 and the second side 30. The third side 40 can be formed by, for example, bending elongated extensions 40A and 40B of the first side 20 and second side 30 until the elongated extensions 40A and 40B are ninety degrees to both the first side 20 and the second side 30, forming a third side 40 that is partially bilaminar.

In order to facilitate ease of bending of the elongated extensions 40A and 40B, a portion of the material at the junction 43 of the first side 20, second side 30, and third side 40 may be removed prior to bending. Other means as are known in the art are contemplated for the third side 40, including, but not limited to, a single-layer side that is welded to the end of the first side 20 and second side 30.

As seen in FIGS. 1-2, the third side 40 preferably comprises at least one aperture 42. The aperture 42 corresponds to an aperture in a flange of one or both of the frame members to which the bracket 10 attaches. In a preferred embodiment, a single aperture 42 is located in the center of the third side 40, so that the bracket can be used on both the left side of the trailer frame and the right side of the trailer frame. In operation, the user inserts a bolt or other fastener through the aperture 42 in the third side, through a corresponding aperture in a flange of one or both frame members, and secures the bolt via a nut or other known device.

In addition to the increased torque resistance that the dimples in the first side 20 and second side 30 provide, securing the bracket 10 to a flange in one or more frame members via the aperture 42 in the third side 40 provides further resistance to torque, due to the bracket 10 attaching to the trailer frame in three planes.

The bracket 10 is preferably made of a rigid metal such as steel, and finished painted or coated, such that the bracket 10 is ready for use in a trailer frame when the bracket 10 is shipped to the user. The size of the bracket can vary without deviating from the scope of the present invention. For example, in trailer frames with wider frame members, the bracket 10 may be wider as well. Generally, the height of the bracket 10 may be slightly less than the width of the frame members, so that the bracket fits under the flange of one or both frame members.

The forgoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention and are not to be construed as limited to the specific embodiments disclosed.

What is claimed is:

1. A reinforcing bracket for a trailer frame that bolts onto the trailer frame at a junction between two frame members, comprising:
a first side adapted to bolt to a first frame member,
a second side adapted to bolt to a second frame member, and
a third side adapted to bolt to a flange of one of said frame members, wherein:
said first side and said second side each include a plurality of dimples, each dimple having at least one aperture therein; and
said third side includes at least one aperture.

2. The bracket as described in claim 1, wherein said first side has two dimples.

3. The bracket as described in claim 2, wherein said two dimples are substantially vertically stacked.

4. The bracket as described in claim 2, wherein said second side has two dimples.

5. The bracket as described in claim 4, wherein said bracket is adapted to fasten to the trailer frame at an angled junction of an A-frame member and a cross-member.

6. The bracket as described in claim 4, wherein said dimples in said first side are substantially vertically stacked, and said dimples in said second side are substantially vertically stacked.

7. The bracket as described in claim 6, wherein said bracket is adapted to fasten to the trailer frame at an angled junction of an A-frame member and a cross-member.

8. The bracket as described in claim 1, wherein said second side has two dimples.

9. The bracket as described in claim 8, wherein said two dimples are substantially vertically stacked.

10. The bracket as described in claim 1, wherein said third side is substantially bilaminar.

11. The bracket as described in claim 1, wherein the angle between the first side and the second side is not ninety degrees.

12. The bracket as described in claim 11, wherein the angle between the first side and the second side is greater than ninety degrees.

13. The bracket as described in claim 11, wherein the angle between the first side and the second side is less than ninety degrees.

14. A reinforcing bracket for a trailer frame that bolts onto said trailer frame at a junction between an A-frame member and a cross-member, comprising:
a first side,
a second side, and
a third side, wherein:
said first side comprises a plurality of dimples, each dimple having an aperture therein;
said second side comprises a plurality of dimples, each dimple having an aperture therein;
said second side is at an angle of greater than ninety degrees to said first side; and
said third side includes at least one aperture.

15. A bolt-together trailer frame comprising:
at least two longitudinal members,
at least two cross-members attached to said at least two longitudinal members by bolts,
two A-frame members each having one end fastened to said at least two longitudinal members by bolts, the other ends fastened to each other by bolts, wherein angles formed between said A-frame members and a cross-member are not ninety degrees, and
a bracket fastening an A-frame member to a cross member, the bracket comprising:
a first side,
a second side, and
a third side, wherein:
the angle between said first side and said second side is not ninety degrees; and
said third side includes at least one aperture.

16. The trailer frame as described in claim 15, wherein said first and second sides of the bracket comprise a plurality of dimples, each dimple having an aperture therein.

17. The trailer frame as described in claim 15, wherein said third side of the bracket is substantially bilaminar.

18. The trailer frame as described in claim 15, wherein the angle between the first side of the bracket and the second side of the bracket is greater than ninety degrees.

19. The trailer frame as described in claim 15, wherein the angle between the first side of the bracket and the second side of the bracket is less than ninety degrees.

20. The trailer frame as described in claim 15, wherein at least one of the A-frame member and the cross member have a flange extending therefrom and the third side of the bracket is fastened to the flange.

21. A bolt-together trailer frame comprising:
at least two longitudinal members,
at least two cross-members attached to the at least two longitudinal members by bolts, wherein at least one cross-member has a flange extending therefrom,
two A-frame members each having one end fastened to said at least two longitudinal members by bolts, the other ends fastened to each other by bolts, wherein angles formed between said A-frame members and cross-member are not ninety degrees, and
a bracket fastening an A-frame member to a cross member, the bracket comprising:
a first side,
a second side, and
a third side, wherein:
the first side includes a plurality of dimples, each dimple having an aperture therein;
the second side includes a plurality of dimples, each dimple having an aperture therein;
the angle between the first side and the second side is not ninety degrees;
the third side is substantially bilaminar and includes at least one aperture; and
the third side is fastened to the flange of the cross-member.
